(19) United States
(12) Patent Application Publication
(10) Pub. No.: US 2012/0062452 A1
(43) Pub. Date: Mar. 15, 2012

(54) METHOD AND APPARATUS FOR TEACHING A CHILD WITH AN ELECTRONIC DEVICE

(76) Inventors: Jamie MacBain, Chicago, IL (US); Gary Aigner, E. Greenwich, RI (US)

(21) Appl. No.: 12/682,558

(22) PCT Filed: Oct. 13, 2008
(86) PCT No.: PCT/US08/79744

§ 371 Date: Jul. 25, 2011

Related U.S. Application Data
(60) Provisional application No. 60/979,323, filed on Oct. 11, 2007.

(51) Int. Cl. G09G 5/00

(52) U.S. Cl. 345/156

(57) ABSTRACT

A handheld electronic device that promotes learning by movement The device includes software that guides the user through various activities via audio and visual cues. The user interacts with the handheld device with movement.

### RELATED APPLICATIONS

This application is a non-provisional of and claims priority to U.S. Provisional Patent Application Ser. No. 60/979,323 filed on Oct. 11, 2007. The content of the provisional application is incorporated herein by reference.

### BACKGROUND

Communication is essential in our society. As children grow, they are exposed to letters of the alphabet and numbers, which are fundamental to learning and the communication process. Teaching the letters of the alphabet and numbers is usually the responsibility of the child's parents and/or school teachers.

### SUMMARY

The introduction of computers in the home and classroom has made learning fun and interesting. It is desirable to provide a means for learning that does not require the continuous presence of an instructor or parent. In addition, it is desirable to provide a means for learning which is stimulating, engaging and fosters interest in learning.

Small handheld electronic devices can assist in promoting the learning process. One embodiment of the present invention includes a small handheld device that promotes learning by movement. The small handheld device includes a personality that will guide the user through various activities via audio and visual cues. The user interacts with the handheld device with movement.

In one embodiment, the invention provides an electronic interactive device comprising a housing, a sleeve coupled to the housing, the sleeve including a handle extending from a side of the sleeve, a display supported by the housing, a processor coupled to the display and supported by the housing, a data store including software stored in a computer readable medium accessible by the processor, the processor being operable to access a routine in the software, and a motion sensor in communication with the processor and supported by the housing, the motion sensor configured to detect motion of the housing as a response to a first instruction presented on the display, the processor receiving feedback from the motion sensor to determine a second instruction to present on the display.

In another embodiment, the invention provides a computer program embodied by a computer readable medium capable of being executed by a processor, the computer program for use in an electronic interactive device. The computer program comprises a routine accessible by the processor, the routine including a play pattern. The play pattern includes instructions to display an character, instructions to a user to move the electronic interactive device a number of times corresponding to the character, instructions to determine the number of times motion is detected, instructions to detect when motion stops, instructions to enter the character that corresponds to the number of times motion is detected, instructions to determine if the entered character matches the displayed character, and instructions to present one of an audio signal and a visual signal to the user if the entered character matches the displayed character.

Other aspects of the invention will become apparent by consideration of the detailed description and accompanying drawings.

### BRIEF DESCRIPTION OF THE DRAWINGS

FIG. 1 is a perspective view of a children's electronic learning device according to one embodiment of the present invention.

FIG. 2 illustrates a plurality of electronic learning devices having unique housings.

FIG. 3 is a schematic diagram of the electronic learning device illustrated in FIGS. 1 and 2.

FIG. 4 is an electronic schematic of a portion of the electronic learning device illustrated in FIGS. 1 and 2.

FIG. 5 is an electronic schematic of a portion of the electronic learning device illustrated in FIGS. 1 and 2.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Although directional references, such as upper, lower, downward, upward, rearward, bottom, front, rear, etc., may be made herein in describing the drawings, these references are made relative to the drawings (as normally viewed) for convenience. These directions are not intended to be taken literally or limit the present invention in any form. In addition, terms such as “first”, “second”, and “third” are used herein for purposes of description and are not intended to indicate or imply relative importance or significance.

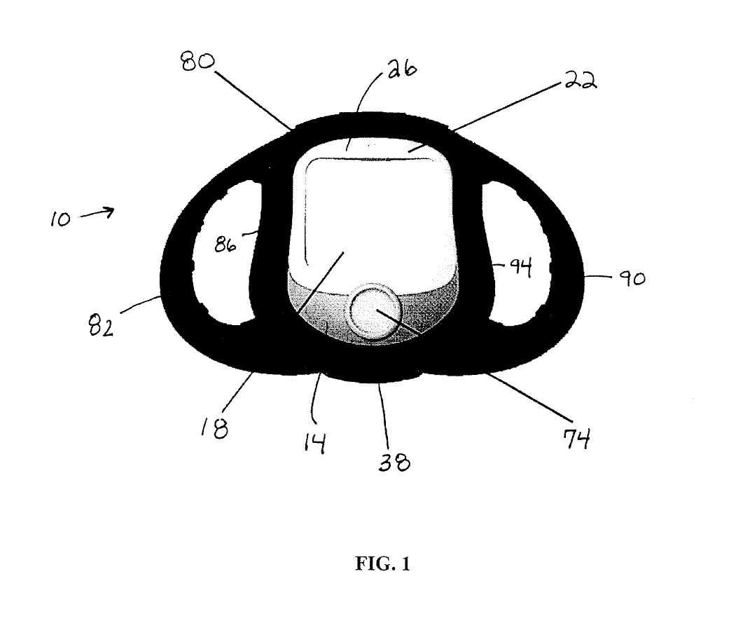

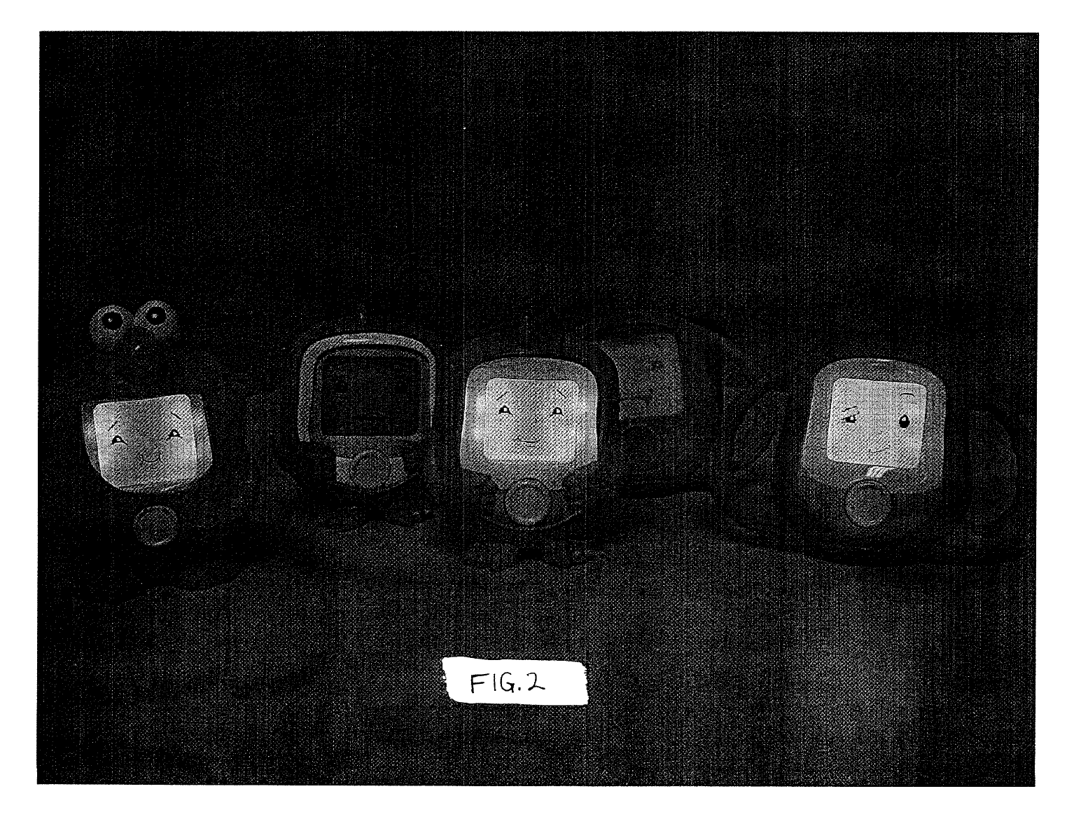

FIGS. 1 and 2 illustrate an electronic interactive device 10 according to one embodiment of the present invention. The electronic interactive device 10 includes a housing 14 having a front wall, a back wall, and a plurality of side walls. In one embodiment, the housing 14 has a width of about 4″ and a height of about 4.5″. The housing 14 is generally no thicker than about 2″.

The electronic interactive device 10 includes a screen 18, such as a LCD supported by the housing 14 and a bezel 22 supported by the housing 14 that surrounds the edges of the screen 18. The screen 18 is large enough for the user to get visual cues from various animations. For example, the screen 18 is about 2″ by about 2″ in size and can be black-and-white or color. The screen 18 also can be backlit.

The electronic interactive device 10 also includes a plurality of lights 26, such as single color or bi-color LCDs supported by the housing 14 and positioned under the bezel 22. The bezel 22 is generally comprised of a translucent or semi-translucent material to see the illumination of the lights 26 through the bezel 22. The electronic interactive device 10 can include driver programs and/or driver chips (e.g., LCD driver chips) to facilitate the function of the screen 18.

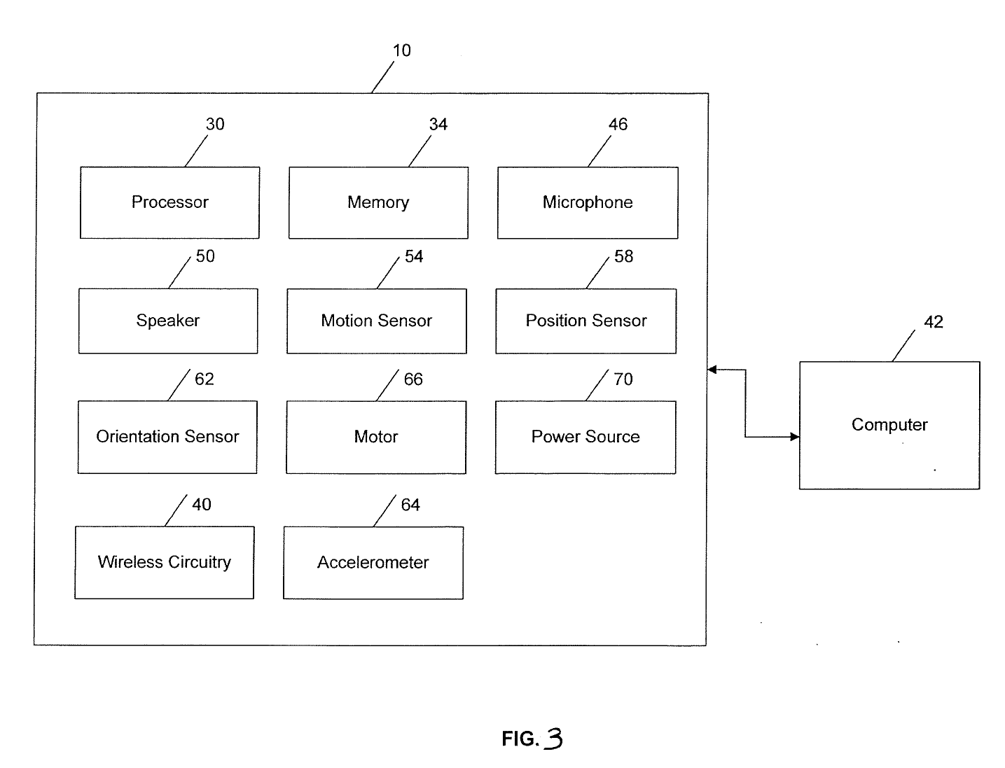

As illustrated in FIG. 3, the electronic interactive device 10 includes a processor 30 supported by the housing 14. The electronic interactive device 10 also includes a data store or memory 34 having computer code and/or a software program for a learning exercise or routine and/or for storing computer code that relates to the operation of the electronic interactive device 10. The memory 34 can be any suitable temporary or permanent information storage device. For example, the memory 34 may include one or more of optical, magnetic, or electronic storage media such as optical or magnetic disks, tapes, sticks, and the like. Storage devices such as these may be used alone or in combination to make up the memory 34. Any suitable number of RAM (random access memory), ROM (read only memory) and EPROM (erasable programmable memory) chips may also be included in the memory 34. The memory 34 can be internal and/or external to the housing of the electronic interactive device 10. In addition, the memory 34 can be or include a cartridge (e.g., in a flash data cartridge), a disk, a tape, or a memory stick. Any suitable amount of storage space may be provided on the memory 34.

Additionally, the interactive device 10 can include one or more ports 38 in the housing 14 and adapted to receive the electronic storage media, such as a cartridge or memory stick. The port 38 includes appropriate circuitry that allows data from the electronic storage media to be read. The port 38 also can accommodate an external connector (e.g., USB connector) that can interface with an external device such as computer 42 or other processor to download programs from an external source (e.g., CD or DVD). The external connector allows the user to connect to external devices such as the Internet via the computer to download learning programs, game content, music, movies, pictures, and other suitable media. In addition, the interactive device 10 includes wireless technology and associated circuitry 40 for communication with the computer 42 and/or other external devices, and/or other similar devices 10, and therefore, does not require a hard-wired connection.

The electronic interactive device 10 also includes a microphone 46 adapted to receive and/or detect sounds and audible signals. The housing 14 includes one or more openings for the microphone 46 to detect the sounds. The electronic interactive device 10 also includes a speaker 50 adapted to output sound waves detectable by the user. The housing 14 includes one or more openings for transmitting the sound waves from the speaker 50 to the user.

The electronic interactive device 10 also includes a motion sensor 54 operable to detect whether the device 10 is in motion and a position sensor 58 operable to detect a position of the device 10. The electronic interactive device 10 also includes an orientation sensor 62, such as a 6-position orientation switch, operable to detect the orientation of the device 10. The electronic interactive device 10 can also include an accelerometer 64 for measuring movement and tilt of the device 10. The electronic interactive device 10 also includes a motor 66 supported by the housing 14. The motor 66 can be eccentrically weighted to provide “force feedback” through the housing 14 to the user.

The electronic interactive device 10 also includes a power source 70, such as one or more batteries supported by the housing 14. The back wall of the housing 14 includes a recess adapted to support the power source 70 and a cover that fits over the power source 70 to enclose the recess. The power source 70 may be a typical hardwired outlet in lieu of or in addition to the one or more batteries. The electronic interactive device 10 also includes a switch 74 supported by the housing 14 and operable to provide input from the user to the processor 30.

The electronic interactive device 10 also includes a removable sleeve 80 that encases the side walls and a portion of the front wall and the back wall of the housing 14. The sleeve 80 can be molded or sculpted to look like a character as illustrated in FIG. 2. In one construction, the sleeve 80 includes a first handle 82 extending from a first side 86 of the sleeve 80 and a second handle 90 extending from a second side 94 of the sleeve 80. The first handle 82 and the second handle 90 can include extensions of the material of the sleeve 80 to aid in gripping of the handles 82, 90. The sleeve 80 can comprise rubber, plastic, or other suitable materials or combinations of materials.

In one embodiment, the sleeve 80 has a thickness of about 2 mm to about 5 mm. The thickness of the sleeve 80 can vary depending on the location. For example, the thickness of the sleeve 80 at the handles 82, 90 may be thicker than around the housing 14 for shock absorption. The overall shape of the sleeve 80 and the handles 82, 90 can vary from the shapes illustrated in FIGS. 1 and 2.

In operation, the electronic interactive device 10 is activated by pressing the switch 74. After activation, the processor 30 randomly accesses one of a plurality of routines stored in memory 34. Upon completion of the routine, the electronic interactive device 10 proceeds to inquire whether another routine should be accessed.

A first routine is a game, for example, that teaches the user the alphabet by using physical interaction to identify letters and objects that start with a specific letter. The game has two phases. In the first phase, the electronic interactive device 10 gives the user a “target” letter and instructions to “hop on down” to that letter. For example, the screen 18 can display the letter “A” and announce the letter name. Every time that the user hops as detected by the motion sensor 54, the screen 18 shows the next letter of the alphabet and the speaker 50 outputs the letter name. Once the user stops hopping for a certain period of time, the letter currently displayed is “entered”. If the entered letter does not correspond with the target letter, the speaker 50 outputs which letter it is and gives an example of a word that starts with the letter and shows a corresponding image on the screen 18. The game then instructs the user to keep going and revert back to the previous mode (hopping and showing the alphabet) where the user left off. If the entered letter matches the target letter, the user receives a reward, i.e., one or more of the lights 26 illuminate in a specific pattern and the motor 66 pulses in sync with the lights 26. The game then proceeds to phase two.

In phase two, the game instructs the user to tilt the unit to find an animal that starts with the target letter. When the unit is tilted, an animal scrolls into the screen 18 from the opposite direction of the tilt angle. If the switch 74 is pressed while the animal that corresponds with the target letter is on the screen 18, the user receives a reward. If the selected image does not correspond with the target letter, the speaker 50 generates an output announcing what the image is and shows the letter that it starts with. The game then reverts (tilting to find the correct image) where the user left off. When phase two is complete, the game inquires whether the user would like to continue and instructs the user to hop (or perform some other act detectable by the motion sensor 54) to play again or press the switch 74 to do something else. If continuing, the game starts at phase one and a different letter can be chosen. If not continuing, then the game proceeds to a different random routine stored in the memory 34.

A second routine is a game that teaches the user numbers from 1-20 and associates the number with a corresponding amount of displayed objects. This game uses verbal and physical interaction. The game has two phases. In the first phase, the electronic interactive device 10 gives the user a “target” number and instructions to yell “stop” when they see the number. Numbers 1-10 begin to appear on the screen 18, in order, and are animated on the screen in various ways. Once the user yells “stop”, the microphone 46 detects the audible signal, and the processor 30 stops at the letter currently displayed and is “entered”. If the entered number does not correspond with the target number, the speaker 50 announces which number it is and displays an equal number of objects on the screen 18. The game instructs the user to keep going and revert back to the previous mode (animating through the numbers) where the user left off. If the number matches the target number, the user receives a reward, i.e., one or more of the lights 26 illuminate in a specific pattern and the motor 66 pulses in sync with the lights 26. The game then proceeds to phase two.

In phase two, the game instructs the user to perform a physical action while the game counts out the corresponding amount of objects while the objects animate onto the screen 18. When phase two is completed, the game inquires whether the user would like to continue and instructs them to hop (or perform some other act detectable by the motion sensor 54) to play again or press the switch 74 to do something else. If continuing, the game starts at phase one and a different number can be chosen. If not continuing, then the game proceeds to a different random routine stored in the memory 34.

The memory 34 also includes additional routines, which can be accessed by the processor 30. The speaker 50 can announce time of day and give something for the user to relate to, such as “it's 12 o'clock, it's lunch time,” “have you eaten yet?” “it is important to have a healthy lunch”. Another routine can help the user choose a snack that is healthy. The processor 30 can express its hunger and several food objects will appear around the screen 18. The user can select a snack by tilting the electronic interactive device 10, which will cause the “wheel of food” to rotate. When the device 10 is “righted” the wheel stops rotating and the image in the “12 o'clock” position is the one that can be selected by pressing the switch 74. Once chosen, the speaker 50 can announce the selected snack and its nutritional value.

Another routine can tell a variety of jokes, riddles, and silly rhymes. When required, the electronic interactive device 10 activates the microphone to make sure that the child is responding (e.g., Knock, Knock . . . if no answer . . . I SAID KNOCK, KNOCK!!). In yet another routine, the electronic interactive device 10 can teach manners to the child. In this routine, the device 10 “accidentally” does something ill-mannered (e.g., sneeze, cough, burp, etc.) and then corrects itself and says “excuse me” to instruct the user on the proper, socially acceptable, manners to be exercised in the situation. In a further routine, the electronic interactive device 10 asks the user to bring the device 10 closer to their ear. The device 10 then whispers a general fact related to one of the educational lessons recently played by or presented to the user.

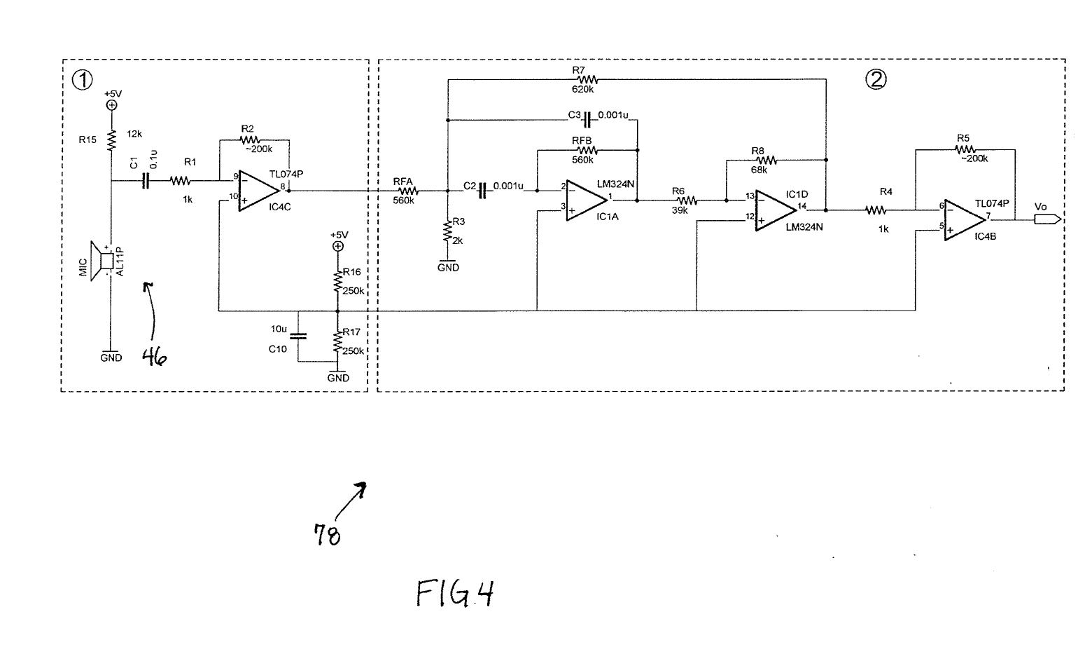

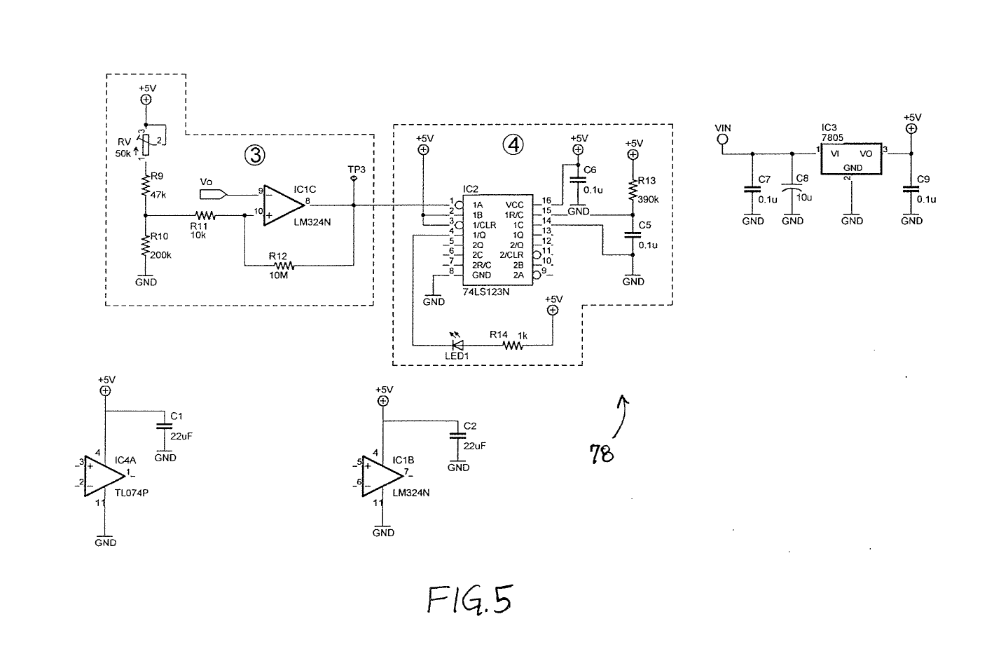

The electronic interactive device 10 also includes an audio detection circuit 78 associated with the microphone 46. The circuit 78 is illustrated in FIGS. 4-5 and operates to detect audible pulses that are encoded on audio signals. The audible pulses can be detectable on audio signals that reside on media or on television or radio broadcasts. The detectable audio pulses range in frequency up to about 50 kHz. For example, detectable audio pulses can be embedded in a CD or DVD supplied or useable with the device 10 if the CD or DVD is played on a CD or DVD player within range of the microphone 46. The audible pulses that are detected by the audio detection circuit 78 cause specific reactions within the device 10. For example, a CD can include a plurality of audio tracks on the CD that relate to the game content or routines stored in the memory 34.

For example, one of the audio tracks on the CD could be a song related to the alphabet, such as the alphabet routine discussed above. As the CD plays, if the microphone 46 and circuit 78 detect the super audible pulses on the audio track, the processor 30 cues the corresponding routine related to the detected pulse. The device 10 proceeds to operate by requesting the actions associated with the letters (as discussed above). In addition, the super audible pulses in the audio track trigger the appropriate animations on the screen 18 and encourage the user to follow along.

As another example, one of the audio tracks on the CD could be a song related to eating right and choosing healthy snacks. If the microphone 46 and circuit 78 detect the super audible pulses on the audio track, the device 10 can present certain images on the screen 18 related to the super audible pulses. For example, the screen 18 can display the “wheel of food” (as discussed above) and can display images of food that correspond with the lyrics of the song. This song encourages the user to follow along with the song and choose the foods that are prompted by the music.

As another example, one of the audio tracks on the CD could be a song related to teaching good manners and habits. The super audible signals can trigger animations of bad habits and bad manners to be displayed on the screen 18. The screen 18 can prompt the user to say please, thank you, excuse me, etc. The words from the user can be detected by the microphone 46 and compared to the proper response. Another audio track on the CD could be a song that plays different versions of the same song, and the detected super audible signals could trigger related images on the screen 18.

Various features of the invention are set forth in the following claims.

What is claimed is:

1. An electronic interactive device comprising:
a housing;
a sleeve coupled to the housing, the sleeve including a handle extending from a side of the sleeve;
a display supported by the housing;
a processor coupled to the display and supported by the housing;
a data store including software stored in a computer readable medium accessible by the processor, the processor being operable to access a routine in the software; and
a motion sensor in communication with the processor and supported by the housing, the motion sensor configured to detect motion of the housing as a response to a first instruction presented on the display, the processor receiving feedback from the motion sensor to determine a second instruction to present on the display.

2. The electronic interactive device of claim 1 further comprising a port supported by the housing, the port configured to receive electronic storage media having software accessible by the processor.

3. The electronic interactive device of claim 1 further comprising a port supported by the housing, the port configured to receive a connector for communication with a second processor.

4. The electronic interactive device of claim 3 wherein the first processor is operable to receive additional routines downloadable from the second processor.

5. The electronic interactive device of claim 1 further comprising a microphone supported by the housing, the microphone operable to detect an audible signal from a user.

6. The electronic interactive device of claim 5 further comprising an audio detection circuit supported by the housing and in communication with the microphone, the audio detection circuit operable to detect a pulse from an audio signal and trigger a response from the software.

7. The electronic interactive device of claim 1 further comprising a plurality of light sources coupled to the housing and visible through the sleeve.

8. The electronic interactive device of claim 1 further comprising an orientation sensor supported by the housing and in communication with the processor, the orientation sensor configured to detect an orientation of the device.

9. The electronic interactive device of claim 1 further comprising an accelerometer supported by the housing and in communication with the processor, the accelerometer configured to detect whether the device is positioned at a tilt.

10. The electronic interactive device of claim 1 further comprising a motor supported by the housing and operable to provide motion to the device based on the user's response to the first instruction.

11. The electronic interactive device of claim 10 wherein the motor is eccentrically weighted.

12. A computer program embodied by a computer readable medium capable of being executed by a processor, the computer program for use in an electronic interactive device, the computer program comprising:
a routine accessible by the processor, the routine including a play pattern, the play pattern including
instructions to display an character;
instructions to a user to move the electronic interactive device a number of times corresponding to the character;
instructions to determine the number of times motion is detected;
instructions to detect when motion stops;
instructions to enter the character that corresponds to the number of times motion is detected;
instructions to determine if the entered character matches the displayed character; and
instructions to present one of an audio signal and a visual signal to the user if the entered character matches the displayed character.

13. The computer program of claim 12 wherein the visual signal includes one of a presentation on a display of the electronic interactive device and a presentation of a plurality of lights in a predetermined pattern.

14. The computer program of claim 12 wherein the play pattern further includes instructions to the processor to enunciate the displayed character if the entered character does not match the displayed character.

15. The computer program of claim 14 wherein the play pattern further includes instructions to the processor to enunciate a word that starts with the displayed character.

16. The computer program of claim 15 wherein the play pattern further includes instructions to the processor to display an image related to the displayed character.

17. The computer program of claim 12 wherein the character is a letter.

18. The computer program of claim 12 wherein the character is a number.
